(19) United States
(12) Patent Application Publication
(10) Pub. No.: US 2026/0305794 A1
(43) Pub. Date: Oct. 8, 2026

(54) DROPPER CONTAINER

(71) Applicant: SHYA HSIN PACKAGING INDUSTRY (CHINA) CO., LTD., Kunshan (CN)

(72) Inventors: Haiying YANG, Kunshan (CN); Weixiang WU, Kunshan (CN); Xiangkai HE, Kunshan (CN); Zhifeng WANG, Kunshan (CN)

(73) Assignee: SHYA HSIN PACKAGING INDUSTRY (CHINA) CO., LTD., Kunshan (CN)

(21) Appl. No.: 19/480,376

(22) PCT Filed: Apr. 24, 2024
(86) PCT No.: PCT/CN2024/089553

§ 371 Date: Oct. 31, 2025

(30) Foreign Application Priority Data
Jun. 9, 2023 (CN) 202310684592.2

(51) Int. Cl. A45D 34/04; B01L 3/02

(52) U.S. Cl. CPC A45D 34/04; B01L 3/0272

(57) ABSTRACT

A dropper container, including: a dropper cap, an inner plug, and a bottle body, where the dropper cap includes a bulb, a dropper, a dropper base, and an outer cap; a first end of the dropper is fixedly connected to the dropper base; a drip nozzle is disposed at a second end of the dropper; the dropper base is fixedly connected to the bulb; the dropper base is disposed in the outer cap; the outer cap is closed onto the bottle body; the inner plug is disposed between the dropper base and the bottle body; an upper surface of the inner plug is in interference fit with a lower surface of the dropper base through a first convex ring; and the bulb, the dropper base, the outer cap, and the inner plug are made of a same plastic material.

### TECHNICAL FIELD

The present disclosure relates to the field of cosmetic packaging, and in particular to a dropper container.

### BACKGROUND TECHNOLOGY

In the field of cosmetic packaging, dropper bottles have been widely used due to their convenience. A dropper bottle includes a bottle body and a dropper cap closed onto the bottle body. The dropper cap includes a bulb, a dropper, and an outer cap. At present, because the bulb, the dropper, and the outer cap are typically made of different materials, the dropper cap needs to be disassembled for recycling, which is very inconvenient.

### CONTENT OF THE INVENTION

In order to overcome the above defects, the present disclosure provides a dropper container. Since the bulb, the dropper base, the outer cap, and the inner plug in the dropper container are made of a same plastic material, components of the dropper container do not need to be disassembled in recycling, which is very convenient for recycling.

To solve the technical problems, the present disclosure employs the following technical solutions:

The present disclosure provides a dropper container, including a dropper cap, an inner plug, and a bottle body, where the dropper cap includes a bulb, a dropper, a dropper base, and an outer cap; a first end of the dropper is fixedly connected to the dropper base; a drip nozzle is disposed at a second end of the dropper; the dropper base is fixedly connected to the bulb; the dropper base is disposed in the outer cap; the outer cap is closed onto the bottle body; the inner plug is disposed between the dropper base and the bottle body; an upper surface of the inner plug is in interference fit with a lower surface of the dropper base through a first convex ring; and the bulb, the dropper base, the outer cap, and the inner plug are made of a same plastic material.

Optionally, the upper surface of the inner plug protrudes upward to form the first convex ring, or the lower surface of the dropper base protrudes downward to form the first convex ring.

Optionally, the dropper base includes a first disc and a first cylindrical portion; the first cylindrical portion is fixedly connected to an upper surface of the first disc; the bulb is fixedly connected to the first cylindrical portion; and a lower surface of the first disc is in interference fit with the upper surface of the inner plug through the first convex ring.

Optionally, the bulb, the dropper, and the dropper base are an integrally formed member made of a same plastic material; an outer sidewall of the first cylindrical portion is provided with an oblique surface and a groove; and a clamping member matching with the groove is disposed on the outer cap.

Optionally, the bulb is an independent member; the bulb includes a squeezable portion; a lower end of the squeezable portion extends radially outward to form a second disc; a lower surface of the second disc is fixedly provided with a second cylindrical portion; the second cylindrical portion is fixedly disposed in the dropper base; and the bulb is in interference fit with the dropper base.

Optionally, the upper surface of the first disc is fixedly provided with a third cylindrical portion; the third cylindrical portion is located outside the first cylindrical portion; an inner sidewall of the third cylindrical portion is provided with a convex rib; and the second cylindrical portion is disposed between the convex rib and the first cylindrical portion.

Optionally, an inner sidewall of a lower end of the second cylindrical portion is provided with a first chamfer; an inner sidewall of an upper end of the convex rib is provided with a second chamfer; and an outer sidewall of an upper end of the first cylindrical portion is provided with a third chamfer.

Optionally, the second cylindrical portion is in interference fit with the first cylindrical portion through a second convex ring; and/or the second disc is in interference fit with the third cylindrical portion through a third convex ring.

Optionally, the dropper and the dropper base are an integrally formed member made of a same plastic material.

Optionally, the dropper and the dropper base each are an independent member; the lower surface of the first disc is fixedly provided with a fourth cylindrical portion; the first end of the dropper is fixedly disposed in the fourth cylindrical portion; and the fourth cylindrical portion is circumferentially provided with notches.

Optionally, the dropper is a glass dropper; three to six notches are formed in the fourth cylindrical portion; distances between every two adjacent ones of the notches are the same; and an inner sidewall of the fourth cylindrical portion is provided with a bump.

Optionally, the bottle body is a plastic bottle body or a glass bottle body; an upper end of the outer cap extends radially inward to form a convex edge; and the outer cap is threadedly connected or snap-fitted to the bottle body.

The present disclosure has the following beneficial effects:
1) The dropper container is neither detached nor sorted according to materials in recycling since the bulb, the dropper base, the dropper, the outer cap, and the inner plug in the dropper container of the present disclosure are made of a same plastic material, which simplifies a recycling process of the product.
2) In order to solve the sealing problem between plastic members, the dropper base is in interference fit with the inner plug through the first convex ring, and the bulb is in interference fit with the dropper base through the second convex ring. Therefore, an additional gasket is omitted in the dropper container of the present disclosure for sealing, reducing the production cost of the product, and facilitating mass production of the product.
3) In order to solve the problem of difficult assembly between the plastic members, the inner sidewall of the lower end of the second cylindrical portion is provided with the first chamfer, the inner sidewall of the upper end of the convex rib is provided with the second chamfer, and the outer sidewall of the upper end of the first cylindrical portion is provided with the third chamfer, facilitating assembly of the bulb to the dropper base. Therefore, the present disclosure is convenient to mount, and strongly practical.

### DESCRIPTION OF THE DRAWINGS

FIG. 1 is an exploded view of a dropper cap and an inner plug according to Embodiment 1 of the present disclosure;

FIG. 2 is an exploded view of a dropper container according to Embodiment 1 of the present disclosure;

FIG. 3 is a sectional view of a dropper container according to Embodiment 1 of the present disclosure;

FIG. 4 is an enlarged view of A shown in FIG. 3;

FIG. 5 is an exploded view of a dropper cap and an inner plug according to Embodiment 2 of the present disclosure;

FIG. 6 is a schematic structural view of a bulb according to Embodiment 2 of the present disclosure;

FIG. 7 is a schematic structural view of a dropper base and a dropper according to Embodiment 2 of the present disclosure;

FIG. 8 is an exploded view of a dropper container according to Embodiment 2 of the present disclosure;

FIG. 9 is a sectional view of a dropper container according to Embodiment 2 of the present disclosure;

FIG. 10 is an enlarged view of B shown in FIG. 9;

FIG. 11 is a sectional view of a dropper container according to Embodiment 3 of the present disclosure;

FIG. 12 is an enlarged view of C shown in FIG. 11;

FIG. 13 is an exploded view of a dropper cap and an inner plug according to Embodiment 4 of the present disclosure;

FIG. 14 is a first schematic structural view of a dropper base according to Embodiment 4 of the present disclosure;

FIG. 15 is a second schematic structural view of a dropper base according to Embodiment 4 of the present disclosure;

FIG. 16 is an exploded view of a dropper container according to Embodiment 4 of the present disclosure;

FIG. 17 is a sectional view of a dropper container according to Embodiment 4 of the present disclosure;

FIG. 18 is an enlarged view of D shown in FIG. 17;

FIG. 19 is a sectional view of a dropper container according to Embodiment 5 of the present disclosure; and

FIG. 20 is an enlarged view of E shown in FIG. 19.

In the figures: 100—bulb, 110—squeezable portion, 120—second disc, 130—second cylindrical portion, 131—first chamfer, and 200—dropper;
300—dropper base, 310—first disc, 320—first cylindrical portion, 321—oblique surface, 322—groove, 323—third chamfer, 324—second convex ring, 325—third convex ring, 330—third cylindrical portion, 331—convex rib, 332—second chamfer, 340—fourth cylindrical portion, 341—notch, and 342—bump; and
400—outer cap, 401—convex edge, 402—clamping member, 403—internal thread, 500—inner plug, 501—first convex ring, 600—bottle body, and 601—outer thread.

### SPECIFIC IMPLEMENTATIONS

The following describes the technical solutions in the embodiments of the present disclosure clearly and completely with reference to the embodiments of the present disclosure. Apparently, the embodiments described are merely some rather than all of the embodiments of the present disclosure. All other embodiments obtained by a person of ordinary skill in the art based on the embodiments of the present disclosure without creative efforts shall fall within the protection scope of the present disclosure.

It should be noted that the terms “first”, “second” and so on in the description and claims of the present disclosure and in the above accompanying drawings are intended to distinguish similar objects but do not necessarily indicate a specific order or sequence. It should be understood that the objects used in such a way may be exchanged under proper conditions to make it possible to implement the described implementations of this application in sequences except those illustrated or described herein. Moreover, the terms “include”, “have” and their variants mean to cover a non-exclusive inclusion. For example, a process, method, system, product or device that includes a list of steps or units is not necessarily limited to those steps or units which are clearly listed. Instead, they may include other steps or units which are not expressly listed or inherent to such a process, method, product, or device.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

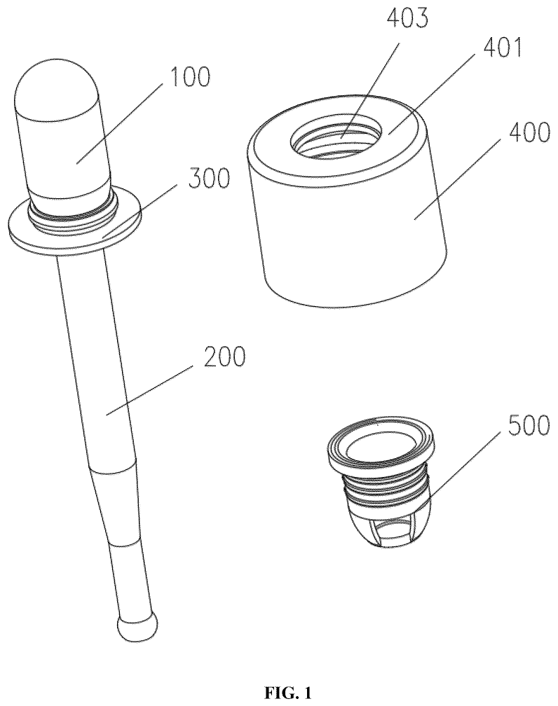

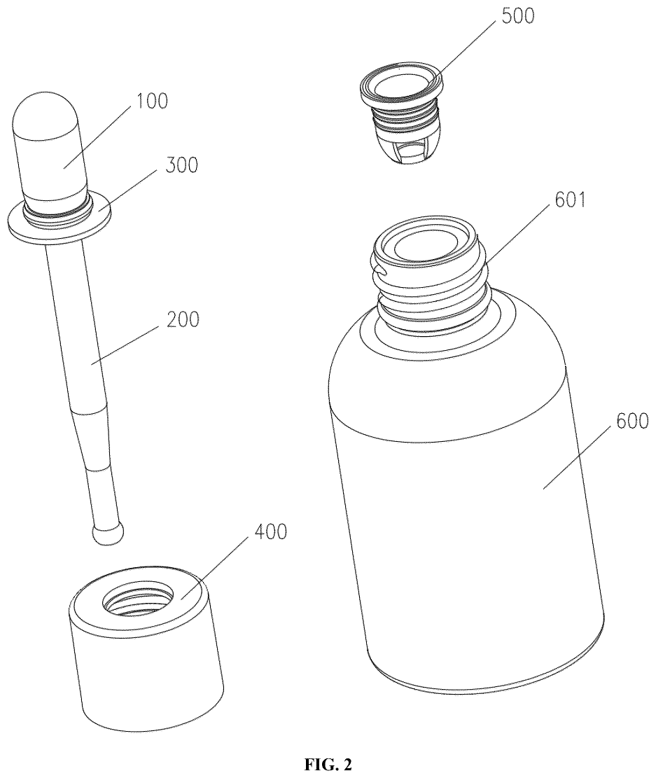

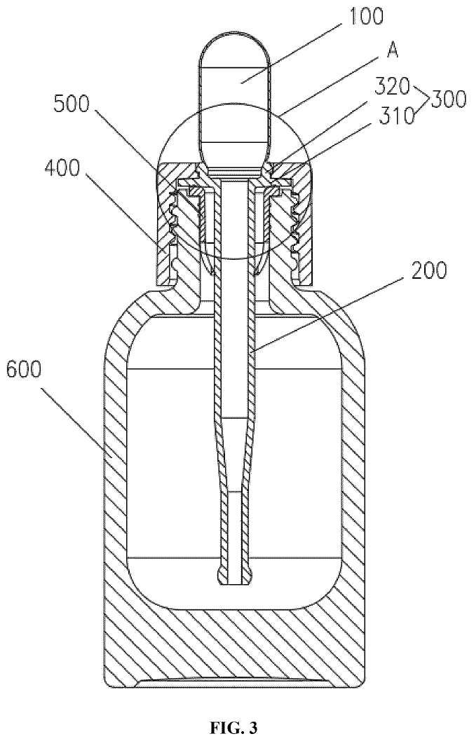

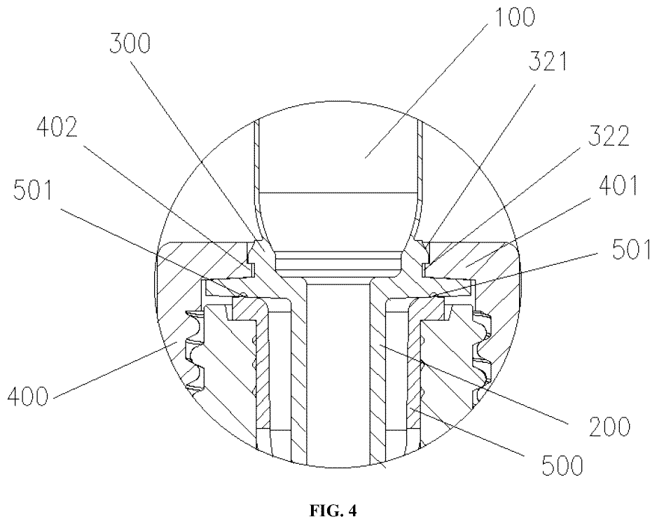

Embodiment 1: As shown in FIGS. 1-4, a dropper container includes a dropper cap, inner plug 500, and bottle body 600. The dropper cap includes bulb 100, dropper 200, dropper base 300, and outer cap 400. A first end of the dropper 200 is fixedly connected to the dropper base 300. A drip nozzle is disposed at a second end of the dropper 200. The dropper base 300 is fixedly connected to the bulb 100. The dropper base 300 is disposed in the outer cap 400. The outer cap 400 is closed onto the bottle body 600. The inner plug 500 is disposed between the dropper base 300 and the bottle body 600. An upper surface of the inner plug 500 is in interference fit with a lower surface of the dropper base 300 through first convex ring 501. The bulb 100, the dropper base 300, the outer cap 400, and the inner plug 500 are made of a same plastic material. In a possible implementation, the plastic material includes one of polypropylene (PP), polycarbonate (PC), 1,4-cyclohexanedimethanol-modified polyethylene terephthalate (PET), and high-density polyethylene (HDPE). Plastic containing benzene rings, such as acrylonitrile-butadiene-styrene copolymer (ABS) and polystyrene (PS), should be avoided if possible. Optionally, the bulb 100, the dropper base 300, the outer cap 400, and the inner plug 500 are made of the PP. As shown in FIG. 3, the bulb 100, dropper 200, and dropper base 300 are manufactured by injection blow molding to form an integrated dropper cap. The dropper cap is disposed on the bottle body 600. The dropper base 300 is fixedly disposed in the outer cap 400. The inner plug 500 is disposed at an opening of the bottle body 600. The outer cap 400 is closed onto the opening of the bottle body 600. The dropper base 300 and the bottle body 600 are sealed by the inner plug 500. Since the dropper base 300 and the inner plug 500 are made of the plastic material, in order to further improve a sealing effect therebetween, the dropper base 300 is in interference fit with the inner plug 500 through first convex ring 501, as shown in FIG. 4. The dropper cap is neither detached nor sorted according to materials in recycling since the bulb 100, the dropper base 300, the outer cap 400, and the inner plug 500 in the dropper container of the present disclosure are made of a same plastic material, which simplifies a recycling process of the product. An additional gasket is omitted in the dropper container of the present disclosure for sealing, reducing the production cost of the product, and facilitating mass production of the product.

In a possible implementation, as shown in FIG. 4, the upper surface of the inner plug 500 protrudes upward to form the first convex ring 501. In another possible implementation, the lower surface of the dropper base 300 protrudes downward to form the first convex ring 501. Optionally, the first convex ring may be an annular structure. There may be one, two or more first convex rings on the inner plug 500 or the dropper base 300. With the first convex ring, the sealing problem between two plastic members, which are the dropper base 300 and the inner plug 500, is solved. That is, the leakage problem between the two plastic members when the gasket is not provided is solved.

As shown in FIG. 3, the dropper base 300 includes first disc 310 and first cylindrical portion 320. The first cylindrical portion 320 is fixedly connected to an upper surface of the first disc 310. The bulb 100 is fixedly connected to the first cylindrical portion 320. A lower surface of the first disc 310 is in interference fit with the upper surface of the inner plug 500 through the first convex ring 501. The expression “the first cylindrical portion 320 is fixedly connected to an upper surface of the first disc 310, and the bulb 100 is fixedly connected to the first cylindrical portion 320” includes at least the following connection methods: When the bulb 100 and the dropper base 300 are an integrally injection-molded member, the first cylindrical portion 320 and the first disc 310, as well as the bulb 100 and the first cylindrical portion 320, are fixed together in injection molding. When the bulb 100 and the dropper base 300 are two independent injection-molded members, the first cylindrical portion 320 and the first disc 310 are fixed together in injection molding, while the bulb 100 and the first cylindrical portion 320 are fixed together in assembly through snap-fit, interference fit, adhesive bonding, etc.

As shown in FIG. 1, the bulb 100, the dropper 200, and the dropper base 300 are an integrally formed member made of a same plastic material. That is, the dropper cap is an integrated plastic member. As shown in FIG. 4, an outer sidewall of the first cylindrical portion 320 is provided with oblique surface 321 and groove 322. Clamping member 402 matching with the groove 322 is disposed on the outer cap 400. In the embodiment, the bulb 100, the dropper 200, and the dropper base 300 are an integrated PP member manufactured by injection blow molding. Therefore, the dropper cap has a high strength and good sealing performance, simplifying the assembly process of the product. The outer cap 400 and the inner plug 500 are also made of the PP, so the whole dropper cap and the inner plug are PP members, and are recycled very conveniently. Through cooperation between the clamping member 402 and the groove 322, the assembly strength between the outer cap 400 and the first cylindrical portion 320 is improved. The oblique surface 321 on the outer sidewall of the first cylindrical portion 320 facilitates assembly of the dropper base 300 from an inner side of the outer cap 400 to an outer side.

As shown in FIGS. 1-4, the bottle body 600 is a plastic bottle body or a glass bottle body. An upper end of the outer cap 400 extends radially inward to form convex edge 401. The outer cap 400 is threadedly connected or snap-fitted to the bottle body 600. The convex edge 401 extends radially inward to form the clamping member 402. The inner plug 500 is disposed at the opening of the bottle body 600. In a possible implementation, an inner sidewall of the outer cap 400 is provided with inner thread 403. An outer sidewall of the bottle body 600 is provided with outer thread 601 threadedly connected to the inner thread 403. The outer cap 400 and the bottle body 600 are threadedly connected through the inner thread and the outer thread.

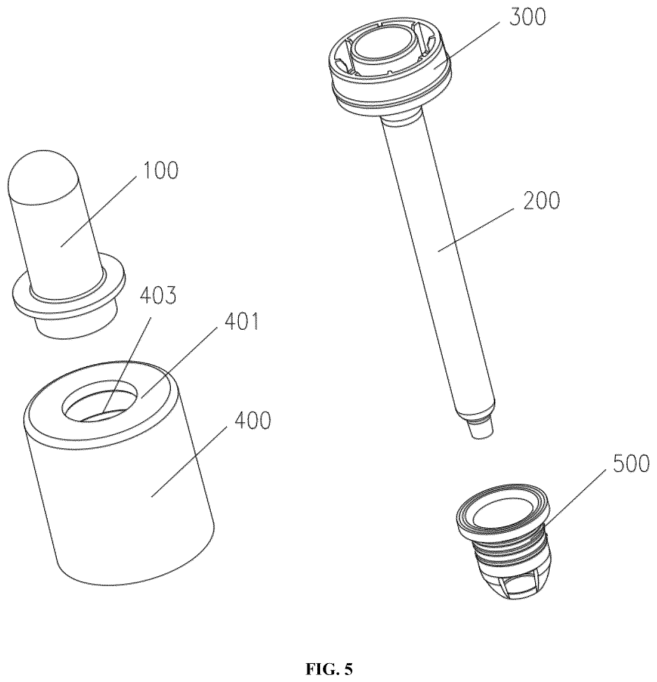

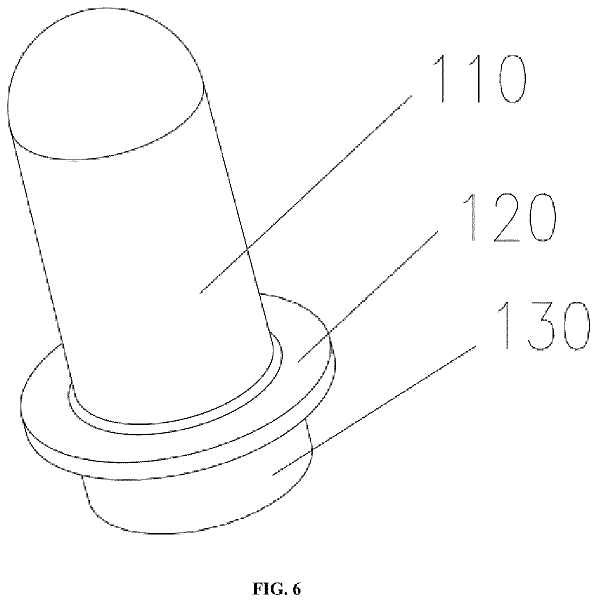

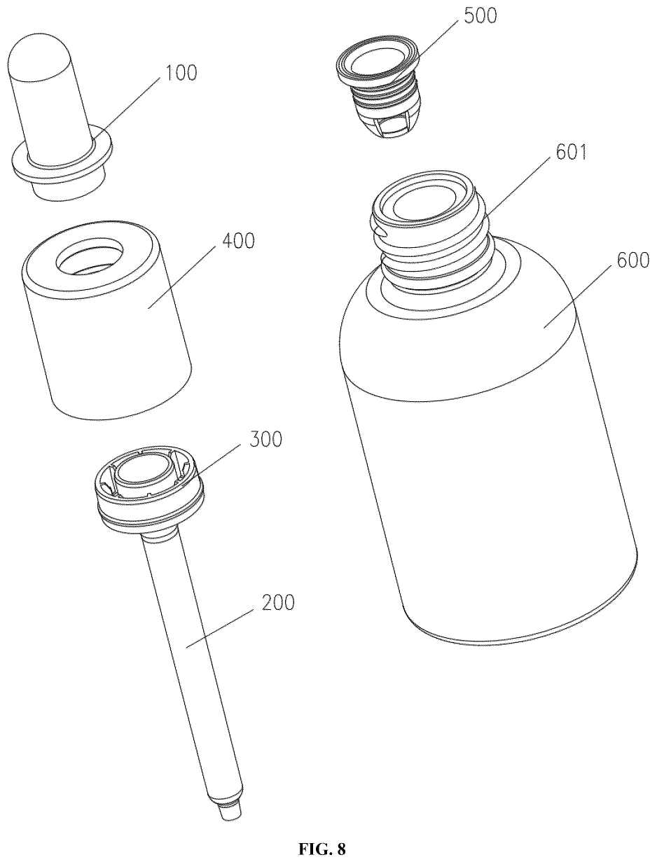

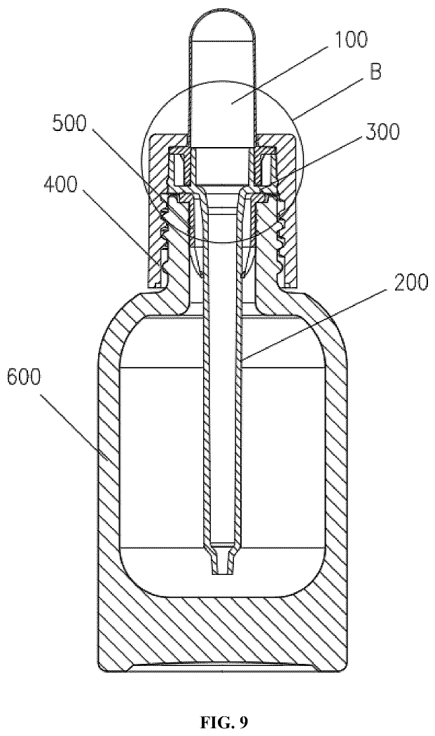

Embodiment 2: As shown in FIGS. 5-10, the bulb 100 is an independent member. The bulb 100 includes squeezable portion 110. A lower end of the squeezable portion 110 extends radially outward to form second disc 120. A lower surface of the second disc 120 is fixedly provided with second cylindrical portion 130. The second cylindrical portion 130 is fixedly disposed in the dropper base 300. The bulb 100 is in interference fit with the dropper base 300. The interference fit between the bulb 100 and the dropper base 300 prevents leakage of the material from a junction therebetween.

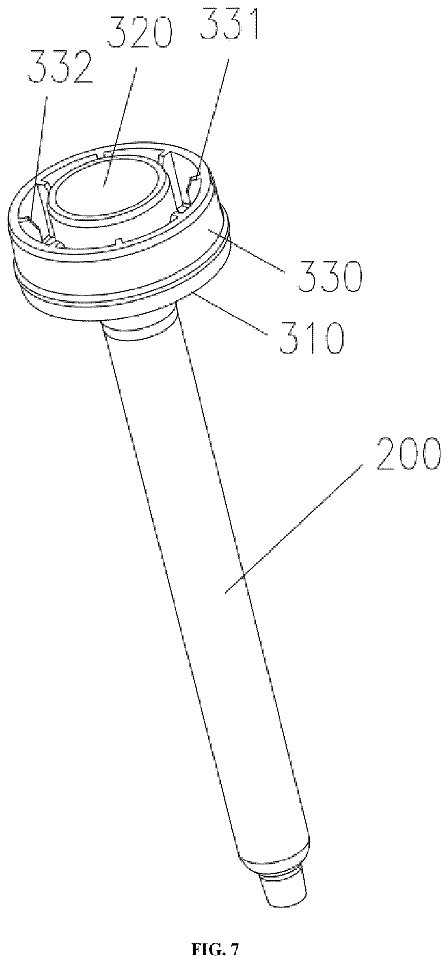

As shown in FIG. 7, the upper surface of the first disc 310 is fixedly provided with third cylindrical portion 330. The third cylindrical portion 330 is located outside the first cylindrical portion 320. An inner sidewall of the third cylindrical portion 330 is provided with convex rib 331. The second cylindrical portion 130 is disposed between the convex rib 331 and the first cylindrical portion 320. In the embodiment, the dropper base 300 includes the first disc 310. At different radial positions, the upper surface of the first disc 310 extends axially upward to form the first cylindrical portion 320 and the third cylindrical portion 330. The third cylindrical portion 330 is located outside the first cylindrical portion 320. The inner sidewall of the third cylindrical portion 330 is circumferentially provided with the convex ribs 331. Referring to FIG. 7, in a possible implementation, the inner sidewall of the third cylindrical portion 330 is provided with eight spaced-apart convex ribs 331. Distances between every two adjacent ones of the convex ribs 331 are the same. The convex ribs 331 are configured to fix the second cylindrical portion 130.

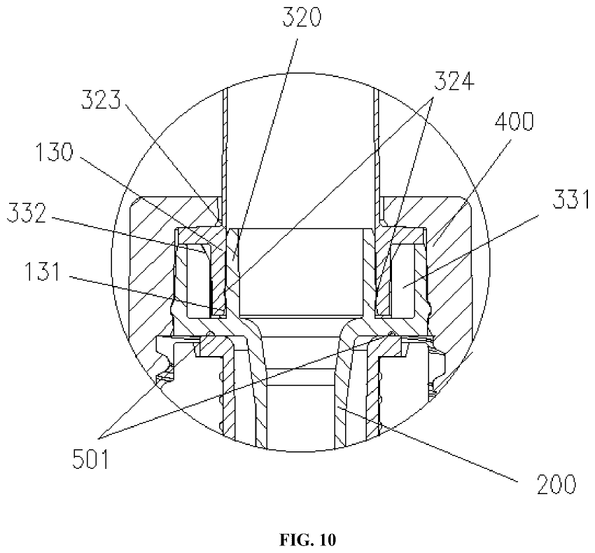

As shown in FIG. 10, an inner sidewall of a lower end of the second cylindrical portion 130 is provided with first chamfer 131. An inner sidewall of an upper end of the convex rib 331 is provided with second chamfer 332. An outer sidewall of an upper end of the first cylindrical portion 320 is provided with third chamfer 323. The first chamfer 131, the second chamfer 332, and the third chamfer 323 facilitate assembly of the bulb 100 to the dropper base 300.

The second cylindrical portion 130 is in interference fit with the first cylindrical portion 320 through second convex ring 324. As shown in FIG. 10, in a possible implementation, the outer sidewall of the first cylindrical portion 320 extends radially outward to form the second convex ring 324. In another possible implementation, an inner sidewall of the second cylindrical portion 130 extends radially inward to form the second convex ring 324.

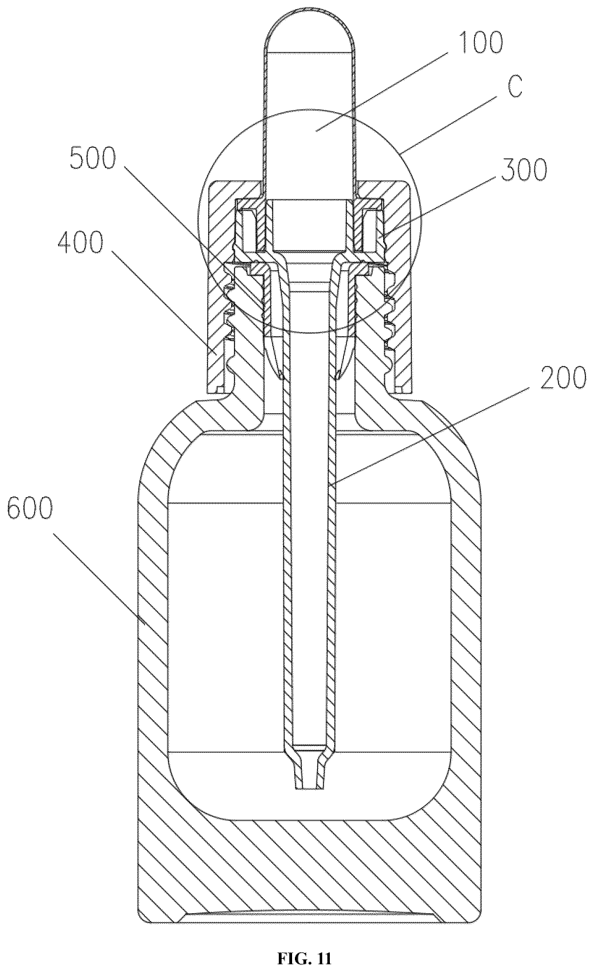

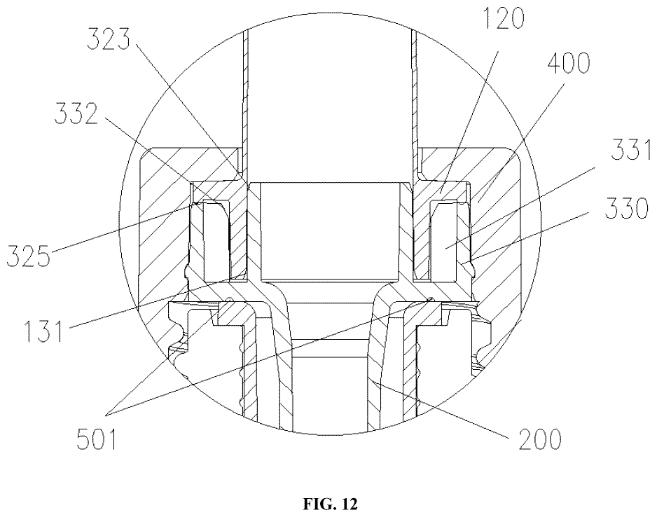

Embodiment 3: The embodiment differs from Embodiment 2 in: The second disc 120 is in interference fit with the third cylindrical portion 330 through third convex ring 325. As shown in FIG. 11 and FIG. 12, in a possible implementation, a lower surface of the second disc 120 protrudes downward to form the third convex ring 325. In another possible implementation, an upper surface of the third cylindrical portion 330 protrudes upward to form the third convex ring 325. In other implementations, the second cylindrical portion 130 is in interference fit with the first cylindrical portion 320 through the second convex ring 324, and the second disc 120 is in interference fit with the third cylindrical portion 330 through the third convex ring 325.

The dropper 200 and the dropper base 300 are an integrally formed member made of a same plastic material. In Embodiment 2 and Embodiment 3, the bulb 100 is the independent member, and the dropper 200 and the dropper base 300 are the integrated member. That is, the integrated dropper cap in Embodiment 1 is disassembled into two independent components. Each component in the dropper cap is manufactured by injection molding. Compared with Embodiment 1, the manufacturing difficulty is reduced. The bulb 100, the dropper 200, the dropper base 300, the outer cap 400, and the inner plug 500 are all PP members. That is, the whole dropper cap is the PP member, and thus is recycled very conveniently. The bulb 100 is in interference fit with the dropper base 300 through the second convex ring 324 and/or the third convex ring 325, preventing leakage of the material from a gap therebetween.

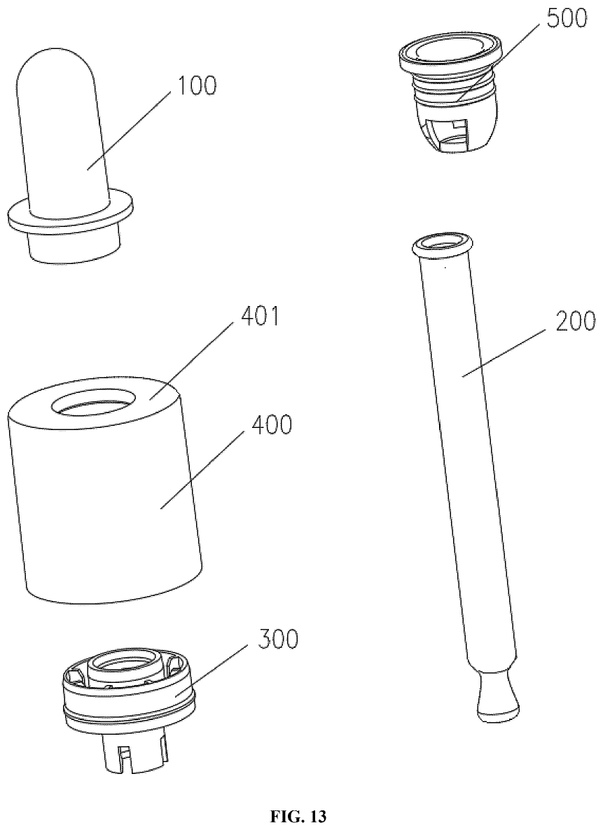

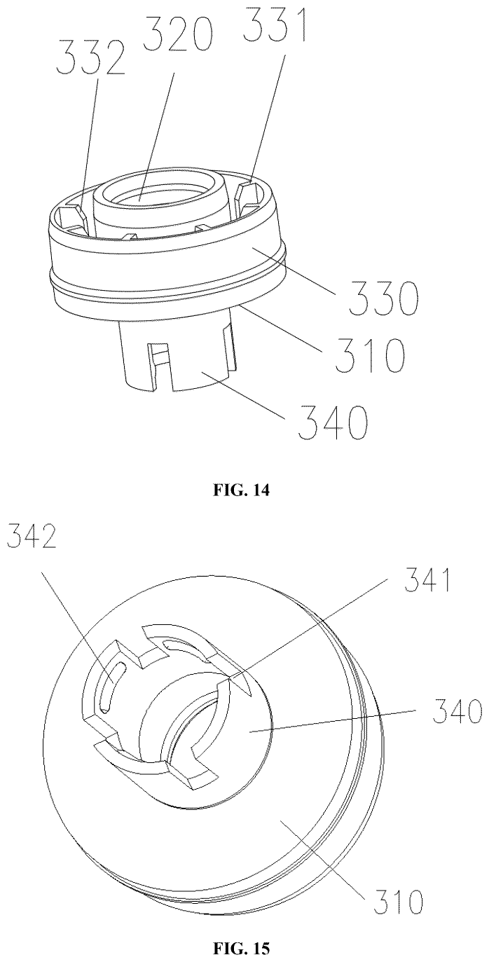

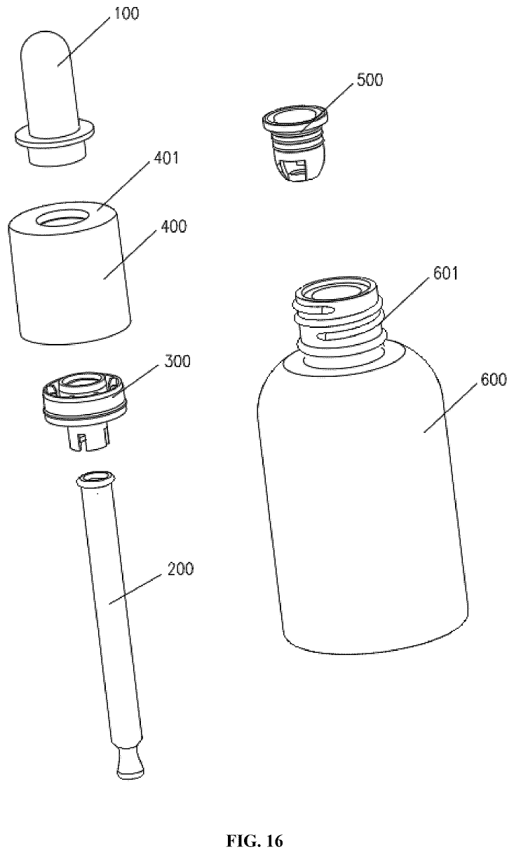

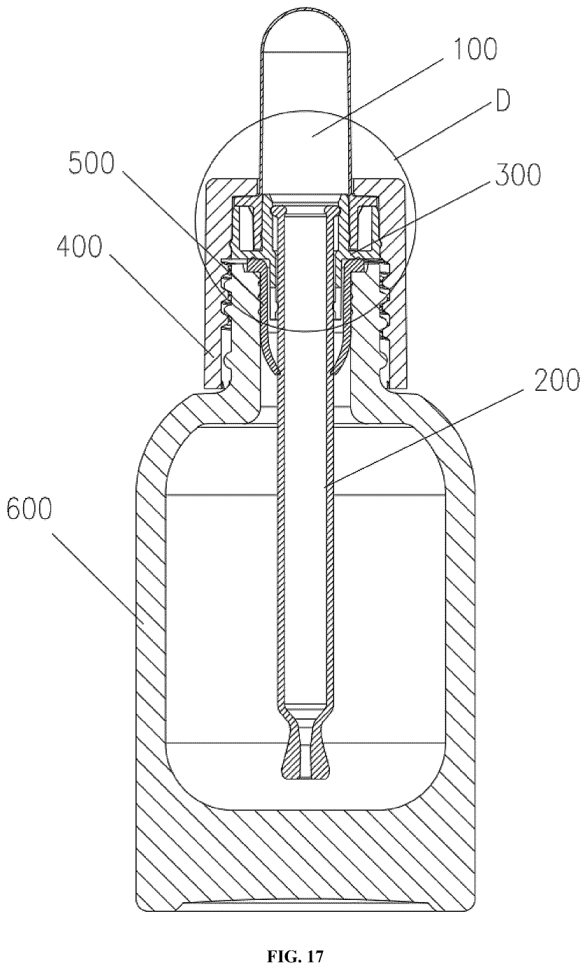

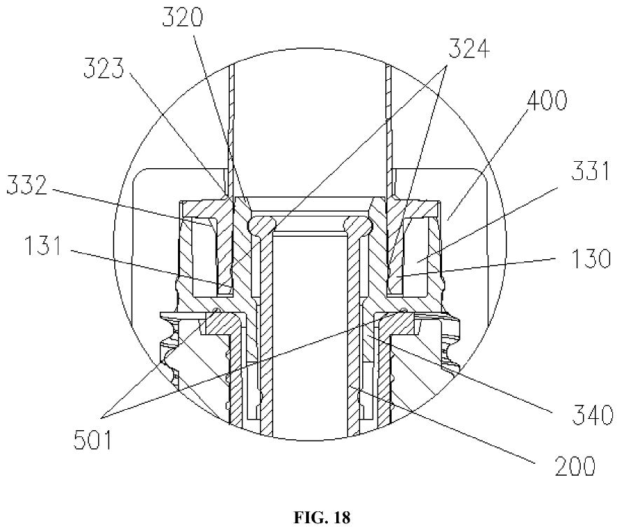

Embodiment 4: As shown in FIGS. 13-18, the dropper 200 and the dropper base 300 each are an independent member. The lower surface of the first disc 310 is provided with fourth cylindrical portion 340. The first end of the dropper 200 is fixedly disposed in the fourth cylindrical portion 340. The fourth cylindrical portion 340 is circumferentially provided with notches 341. In the embodiment, the bulb 100, the dropper 200, and the dropper base 300 are all independent members, and are manufactured by injection molding. Compared with Embodiment 2, the manufacturing difficulty is further reduced in the embodiment. As shown in FIG. 14 and FIG. 18, the first cylindrical portion 320 communicates with the fourth cylindrical portion 340. The first end of the dropper 200 is inserted into the first cylindrical portion 320 and the fourth cylindrical portion 340. The dropper 200 may be a plastic dropper, and may also be a glass dropper.

Optionally, the dropper 200 is the glass dropper. When the dropper 200 is made of glass, the manufacturing cost of the dropper container is reduced. Moreover, since the dropper is interference-fitted into the dropper base 300, the dropper is directly pulled out of the dropper base in recycling, facilitating sorting and recycling. As shown in FIG. 15, three to six notches 341 are formed in the fourth cylindrical portion 340. Distances between all adjacent notches 341 are the same. An inner sidewall of the fourth cylindrical portion 340 is provided with bump 342. In view of a large tolerance of the glass dropper, the notches are formed in the fourth cylindrical portion 340, increasing assembly elasticity of the fourth cylindrical portion, and facilitating smooth assembly of the glass dropper. The bump 342 is configured to fix the dropper, preventing shaking of the dropper. As an optional implementation, four notches 341 are formed in the fourth cylindrical portion 340 in FIG. 15. The notches separate the fourth cylindrical portion 340 into four branches. An inner sidewall of each branch is provided with one bump. In the embodiment, the second cylindrical portion 130 is in interference fit with the first cylindrical portion 320 through the second convex ring 324.

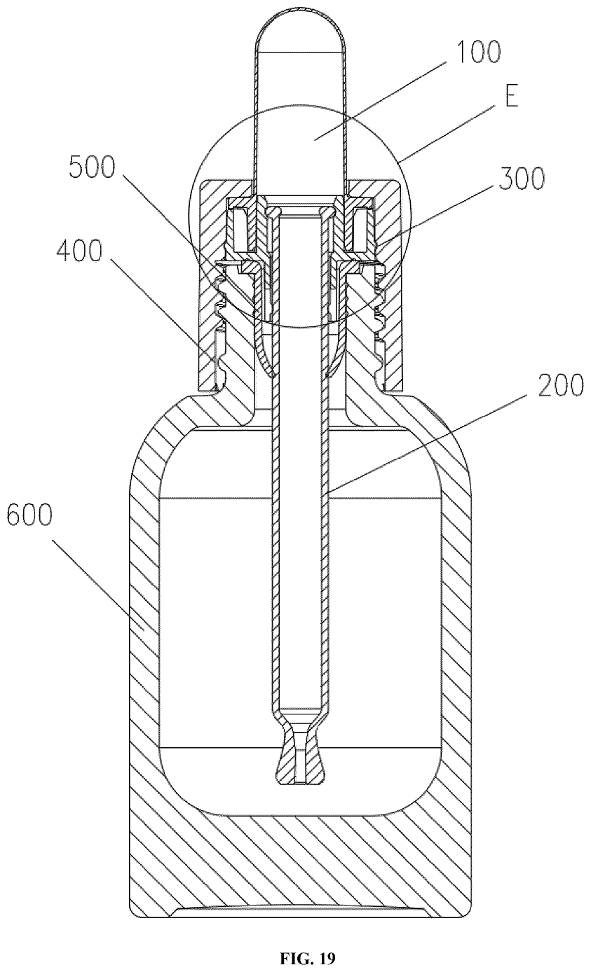

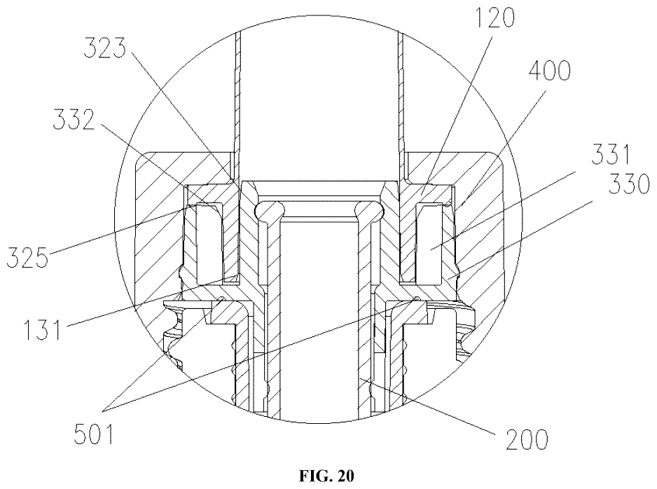

Embodiment 5: As shown in FIGS. 19-20, the embodiment differs from Embodiment 4 in: The second disc 120 is in interference fit with the third cylindrical portion 330 through the third convex ring 325.

It should be noted that those of ordinary skill in the art can further make variations and improvements without departing from the conception of the present disclosure. These variations and improvements all fall within the protection scope of the present disclosure. Therefore, the protection scope of the present disclosure shall be subject to the appended claims.

1. A dropper container, comprising: a dropper cap, an inner plug, and a bottle body, wherein the dropper cap comprises a bulb, a dropper, a dropper base, and an outer cap; a first end of the dropper is fixedly connected to the dropper base a drip nozzle is disposed at a second end of the dropper; the dropper base is fixedly connected to the bulb; the dropper base is disposed in the outer cap; the outer cap is closed onto the bottle body; the inner plug is disposed between the dropper base and the bottle body; an upper surface of the inner plug is in interference fit with a lower surface of the dropper base through a first convex ring; and the bulb, the dropper base, the outer cap, and the inner plug are made of a same plastic material.

2. The dropper container according to claim 1, wherein the upper surface of the inner plug protrudes upward to form the first convex ring, or the lower surface of the dropper base protrudes downward to form the first convex ring.

3. The dropper container according to claim 2, wherein the dropper base comprises a first disc and a first cylindrical portion; the first cylindrical portion is fixedly connected to an upper surface of the first disc; the bulb is fixedly connected to the first cylindrical portion; and a lower surface of the first disc is in interference fit with the upper surface of the inner plug through the first convex ring.

4. The dropper container according to claim 3, wherein the bulb, the dropper, and the dropper base are an integrally formed member made of the same plastic material; an outer sidewall of the first cylindrical portion is provided with an oblique surface and a groove; and a clamping member matching with the groove is disposed on the outer cap.

5. The dropper container according to claim 3, wherein the bulb is an independent member; the bulb comprises a squeezable portion; a lower end of the squeezable portion extends radially outward to form a second disc; a lower surface of the second disc is fixedly provided with a second cylindrical portion; the second cylindrical portion is fixedly disposed in the dropper base; and the bulb is in interference fit with the dropper base.

6. The dropper container according to claim 5, wherein the upper surface of the first disc is fixedly provided with a third cylindrical portion; the third cylindrical portion is located outside the first cylindrical portion; an inner sidewall of the third cylindrical portion is provided with a convex rib; and the second cylindrical portion is disposed between the convex rib and the first cylindrical portion.

7. The dropper container according to claim 6, wherein an inner sidewall of a lower end of the second cylindrical portion is provided with a first chamfer; an inner sidewall of an upper end of the convex rib is provided with a second chamfer; and an outer sidewall of an upper end of the first cylindrical portion is provided with a third chamfer.

8. The dropper container according to claim 7, wherein the second cylindrical portion is in interference fit with the first cylindrical portion through a second convex ring; and/or the second disc is in interference fit with the third cylindrical portion through a third convex ring.

9. The dropper container according to claim 5, wherein the dropper and the dropper base are an integrally formed member made of the same plastic material.

10. The dropper container according to claim 5, wherein the dropper and the dropper base each are an independent member; the lower surface of the first disc is fixedly provided with a fourth cylindrical portion; the first end of the dropper is fixedly disposed in the fourth cylindrical portion; and the fourth cylindrical portion is circumferentially provided with notches.

11. The dropper container according to claim 10, wherein the dropper is a glass dropper; three to six notches are formed in the fourth cylindrical portion; distances between every two adjacent ones of the notches are the same; and an inner sidewall of the fourth cylindrical portion is provided with bumps.

12. The dropper container according to claim 1, wherein the bottle body is a plastic bottle body or a glass bottle body; an upper end of the outer cap extends radially inward to form a convex edge; and the outer cap is threadedly connected or snap-fitted to the bottle body.

13. The dropper container according to claim 6, wherein the dropper and the dropper base are an integrally formed member made of the same plastic material.

14. The dropper container according to claim 7, wherein the dropper and the dropper base are an integrally formed member made of the same plastic material.

15. The dropper container according to claim 8, wherein the dropper and the dropper base are an integrally formed member made of the same plastic material.

16. The dropper container according to claim 6, wherein the dropper and the dropper base each are an independent member; the lower surface of the first disc is fixedly provided with a fourth cylindrical portion; the first end of the dropper is fixedly disposed in the fourth cylindrical portion; and the fourth cylindrical portion is circumferentially provided with notches.

17. The dropper container according to claim 7, wherein the dropper and the dropper base each are an independent member; the lower surface of the first disc is fixedly provided with a fourth cylindrical portion; the first end of the dropper is fixedly disposed in the fourth cylindrical portion; and the fourth cylindrical portion is circumferentially provided with notches.

18. The dropper container according to claim 8, wherein the dropper and the dropper base each are an independent member; the lower surface of the first disc is fixedly provided with a fourth cylindrical portion; the first end of the dropper is fixedly disposed in the fourth cylindrical portion; and the fourth cylindrical portion is circumferentially provided with notches.

19. The dropper container according to claim 2, wherein the bottle body is a plastic bottle body or a glass bottle body; an upper end of the outer cap extends radially inward to form a convex edge; and the outer cap is threadedly connected or snap-fitted to the bottle body.

20. The dropper container according to claim 3, wherein the bottle body is a plastic bottle body or a glass bottle body; an upper end of the outer cap extends radially inward to form a convex edge; and the outer cap is threadedly connected or snap-fitted to the bottle body.
